(19) United States
(12) Patent Application Publication
(10) Pub. No.: US 2003/0039948 A1
(43) Pub. Date: Feb. 27, 2003

(54) Voice enabled tutorial system and method

(76) Inventor: Steven J. Donahue, Hollywood, FL (US)

Correspondence Address: HOLLAND & KNIGHT, LLP, ONE EAST BROWARD BLVD., SUITE 1300, FT LAUDERDALE, FL, 33301

(21) Appl. No.: 10/214,748

(22) Filed: Aug. 7, 2002

Related U.S. Application Data
(60) Provisional application No. 60/311,239, filed on Aug. 9, 2001.
(60) Provisional application No. 60/324,734, filed on Sep. 25, 2001.

(51) Int. Cl. G09B 7/00

(52) U.S. Cl. 434/322

(57) ABSTRACT

A system and method for teaching a user with a communications device linked to a computer system containing a database with a plurality of lessons wherein each lesson has a number of lesson elements with educational components and assessment components. The method compiles a first subset of lesson elements based upon a profile of the user, presents the first subset of lesson elements to the user, obtains user responses to assessment components in the presented first subset of lesson elements, compares the user responses to predetermined assessment responses, and adaptively modifies the first subset of lesson elements to obtain a unique second subset of lesson elements based upon the comparing step.

This is a regular patent application based upon provisional patent application Serial No. 60/311,239 titled “VEL: Voice Recognition Enabled Learning” filed Aug. 9, 2001, and provisional patent application Serial No. 60/324,734 titled “Tutorial System and Method” filed Sep. 25, 2001.

### FIELD OF THE INVENTION

The present invention relates to a voice enabled tutorial system and method of teaching which creates a lesson plan unique to a particular student or group of students and continues to adapt and modify the lesson plan to account for the student's or group's mastery of the previous lessons.

### BACKGROUND OF THE INVENTION

The increasing value of a skilled, educated person in today's economy has created a demand for more forms of education and improved methods of teaching. Education comprises the second largest part of the gross domestic product in the United States. The childcare, kindergarten through twelfth grade, post-secondary, and corporate training markets represent a $724 billion a year market in the United States. There is a need in the market for more teaching tools, and particularly, for a more effective and more efficient teaching tools.

Most the of the existing teaching methods and tools available today are rigid and not structured to meet the requirements of a particular student. For example, in most classroom settings, a student is placed in a grade level which is initially dependent upon the age of the student. An assessment test may be given to determine where to place the student within a particular subject level if the school offers multiple levels. An English course, for example, may include a remedial level, an average or “regular” level, and an advanced or “honor” level. Once the student is placed within a course, he or she, along with the rest of the class—is given a series of lessons taken from a lesson plan chosen by the instructor which may or may not be approved by a faculty head. The student is tested periodically and at the end of each semester, and at the end of the school year the instructor gives the student a grade which is indicative of the student's proficiency in the course. If the student receives a passing grade, then he or she may advance to the next level. If the student fails the course, then the student must repeat the course. If the student fails too many courses, the student may be required to repeat the grade. In some grade school systems, the student may take remedial courses during the summer break between school years which, if successfully completed, allow the student to continue to the next level. The lesson plan is rarely, if ever, changed to accommodate the proficiency level of a particular student, and sometimes even for a small group of students.

Because of the sheer number of students and the lack of resources available, class sizes prevent meaningful one-on-one interaction between teacher and student. In some schools, it is limited or non-existent. The more fortunate students who are struggling with the subject matter may get private tutoring or help from family or friends. The students who excel in a particular subject matter receive the top grade and must usually wait until the following school year to advance to the next level. Some exceptional students or gifted students simply lose interest in the course because of the lack of intellectual stimulation and score poorly.

Some subjects, like language, are especially prone to a wide array of learning proficiencies. The latest census information indicates that the population of the United States is more diverse than ever. Today's classroom may have students speaking more than one language, or speaking a second language at home. Many students, including adult students, whether learning English or another language, need individual attention to learn a particular linguistic lesson. In some cases, a student may have a speech impediment such that he or she cannot pronounce certain sounds properly. Such speech deficiencies require individualized training in which the lessons can be modified to emphasize problem areas.

The use of technology for teaching is not new. Many classrooms around the United States and in other countries have been equipped with audio/visual devices for decades. Teachers have incorporated the use of slide projectors, movie projectors, and overhead projectors in their lessons for many years. Now, with the vast use of networked technologies, such as the Internet and the World Wide Web, new teaching tools and methods are being created that utilize these communication technologies. Many modern-day classrooms have been equipped with computer workstations. However, most of the teaching tools and methodologies used with computers today adopt the classic classroom paradigm described above. The tools fail to consider individual traits, characteristics or background information, and lack the combination of (i) the individualized assessment of the student, and (ii) the adaptive modification or customization of the particular lesson plan suited for that student, both of which allow that student to proficiently and efficiently learn the subject matter.

There is a need for a teaching tool that allows a student to progress in the learning of a subject matter in a manner suited, customized or adapted for that particular student. There is a need for such an individualized teaching tool which does not demand the extensive resources required for one-on-one or small classroom settings. There is also a need for a teaching tool which assesses the proficiency and progress rate of a particular student and modifies the lesson plan to accommodate that student's strengths and weaknesses. There is a need for a teaching method that modifies the student's lesson plan to allow the student to progress more rapidly if the student has mastered the previous lessons, and to give the student more in-depth lessons in the areas in which the student is deficient.

### SUMMARY OF THE INVENTION

It is therefore among the objectives of the present invention to provide a tutorial system which presents the user with lessons unique and customized to meet his or her particular needs, which accounts for profile or background information regarding the user as well as the user's performance with prior lessons to formulate new lessons, unique for that user, which assesses the user's mastery of the unique assembled lessons and assembles further lessons to reinforce areas in which the user is experiencing difficulty, which can be provided over a computer or telecommunications network, and, which permits interaction between users and/or teachers to progress through lessons together.

These objectives are accomplished in an adaptive system and method for teaching in which a computer system and a linkage such as a telecommunications network are utilized to present a plurality of lessons to a user wherein each lesson has a number of lesson elements each with educational components and assessment components. The user, or a plurality of users (sometimes gathered into a group or cohort), is represented by a profile. The adaptive method compiles a first subset of lesson elements based upon the profile with a compiler associated with a server, presents the first subset of lesson elements to the user, obtains user responses to assessment components in the presented first subset of lesson elements, compares the user responses to predetermined assessment responses, and adaptively modifies the first subset of lesson elements to obtain a unique, second subset of lesson elements based upon the comparing step. Compiling, modification and presentation subsystems are utilized in the adaptive method and system of this invention which are sometimes embodied on a computer readable medium as programming instructions.

### BRIEF DESCRIPTION OF THE DRAWINGS

The structure, operation and advantages of this invention will become further apparent upon consideration of the following description, taken in conjunction with the accompanying drawings, wherein:

FIG. 1 is a schematic flow chart of the adaptive teaching method; and system of this invention;

FIG. 2 is a more detailed flow chart of the method and system depicted in FIG. 1;

FIG. 3 diagrammatically illustrates a flow chart of the major components of a multi-user embodiment of the method and system of FIG. 1;

FIG. 4 diagrammatically illustrates an exemplary display for a multi-user embodiment of the subject method;

FIG. 5 illustrates an application of the method herein using an Internet connection between user computers or workstations, and a computer system having a remote system server;

FIG. 5A is a partial flow chart similar to FIG. 5, except depicting a local network connection between multiple users and the Internet;

FIG. 6 diagrammatically illustrates a computer equipped with audio/visual equipment which can be utilized to operate the method herein; and

FIG. 7 diagrammatically illustrates the tutorial system embodied in a telecommunications system linking users via telephonic devices to the remote system server of a computer system.

### DETAILED DESCRIPTION OF THE PREFERRED EMBODIMENTS

The present invention relates to a tutorial system and method 10 of teaching which creates a lesson plan unique to a particular student or group of students and continues to adapt and modify the lesson plan to account for the student's or group's mastery of the previous lessons. The tutorial system and method 10 of teaching takes the unique characteristics of a particular student or group of students into consideration in order to determine what to include in the customized lesson plan. The present invention also relates to a method of teaching involving two or more students such that the lesson plan is customized and adaptively modified to meet the needs of a group or cohort of students. The group of students is identified as a cohort primarily because the group progresses together to a common goal in the learning process and because the members of the cohort may share some common characteristic, such as their proficiency in learning the particular subject matter. Throughout the specification, descriptions of the tutorial system and method 10 referring to a single user or student may also apply to a group or cohort of users where applicable.

As described in separate embodiments below, the tutorial system relates to a methodology of teaching utilizing communications technology such as a personal computer system, a computer network system (LAN or WAN), the Internet, a telecommunications system including communications devices, and computer programs and computer modules or routines to embody the tutorial system. The embodiments described and shown herein are illustrated of the many advantageous uses of the innovative teaching method of this invention.

The method 10 of this invention is implemented using hardware or software, or a combination of hardware and software, and such implementations would be known to one of ordinary skill in the art. The system for practicing the method 10 herein may be embodied in a single computer system having separate elements or means for performing the individual functions or steps described below, or means combining the performance of any of the inventive steps disclosed, or may be arranged in a distributed computer system interconnected by any suitable means as would be known by one of ordinary skill in the art.

No particular kind of computer system is required to implement the method herein, but essentially any general purpose computer would be suitable with appropriate performance capabilities, as would be known to one of ordinary skill in the art. The operations of such a computer, as described above, may be according to a computer program contained on a medium for use in the operation or control of the computer as would be known to one of ordinary skill in the art. The computer medium which may be used to hold or contain the computer program product may be a fixture of the computer such as an embedded memory, or may be on a transportable medium such as a disk or chip, as would be known to one of ordinary skill in the art.

The invention is not limited to any particular computer program, logic, language or instruction. Without limiting the principles of the disclosed invention any such computer system can include, inter alia, at least a computer readable medium allowing a computer to read data, instructions, messages or message packets, and other computer readable information from the computer readable medium. The computer readable medium may include non-volatile memory, such as read only memory (ROM), electrically erasable programmable read only memory (EEPROM), erasable programmable read only memory (EPROM), flash memory, floppy disk, disk drive memory, compact disc read only memory (CD-ROM), and other permanent storage. Additionally, a computer readable medium may include, for example, volatile storage such as random access memory (RAM) buffers, extended data out random access memory (EDO RAM), cache memory, and network circuits. Furthermore, the computer readable medium may include computer readable information in a transitory state medium such as a network link and/or a network interface, including a wired network or a wireless network, that allow a computer to read such computer readable information.

As described in more detail below, a connection or link is established between the computer system and user in order to provide access to the tutorial system and method 10 of this invention. This connection is obtained with a “communications device,” which, for purposes of the specification and claims, refers to any one of a number of electronic and/or audio devices capable of interconnecting the user with a computer system such as a computer, a workstation, a telephone (land line or wireless), a telecommunications system, the Internet and any combination thereof.

The tutorial system and adaptive teaching method 10 of the present invention utilizes small, reusable interactive learning units which are referred to as lesson elements throughout the specification, and claims. A plurality of lesson elements make up a lesson or lesson plan. In one embodiment, the content of a subject matter is broken down or categorized into a curricular taxonomy having five (5) dimensions each having up to seven (7) levels. Each lesson includes at least one lesson element, and each lesson falls within a level of one of the dimensions. For example, in a linguistics tutorial system, the linguistics tutorial may have five dimensions: (i) pronunciation or phonics, (ii) spelling, (iii) grammar, (iv) vocabulary, and (v) comprehension. Each of the 5 dimensions of the tutorial may have seven (7) levels. Accordingly, for an English linguistic tutorial, a level 1 pronunciation lesson may include lesson elements including (i) learning how to pronounce the sounds that make up the word “thank”, (ii) pronouncing similar sounding words already learned, and (iii) identifying the correct pronunciation of the word from among a group of similar sounding words. A level 1 comprehension lesson may include lesson elements instructing the user on (i) how the word is used in the context of a sentence, and (ii) its meaning in the context of a sentence or paragraph. The particular level from which that lesson pertains may include many other lessons designed to teach other words of the same or similar level of difficulty. Other lesson levels, representing varying degrees of difficulty, are employed to teach simpler or more complex words. The following exemplary table illustrates a curricular taxonomy for a linguistics tutorial:

Exemplary 5-Dimensional Linguistic Lesson Plan

| Lesson Plan No. | Lesson Elements |
|---|---|
| LP1 (Lesson Pronunciation 1) | A, B, C, D, E, F |
| LP2 (Lesson Pronunciation 2) | A, B, C, D, E, F, G, H |
| LP3 (Lesson Pronunciation 3) | A, B |
| LP1 (Lesson Grammar 1) | A, B, C |
| LG2 | A, B, C, D, E, F |
| LS1 | A, B, C, D, E, F |
| LS2 | A, B, C, D |
| LV1 | A, B, C, D |
| LV2 | A, B, C, D, E |
| LC1 | A, B, C, D, E, F, G, H, I, J |
| LC2 | A, B, C, D, E, F, G, H, I, J |

P = Pronunciation,
G = Grammar,
S = Spelling,
V = Vocabulary,
C = Comprehension

In the exemplary 5-dimensional linguistic lesson plan, there are three levels of pronunciation lessons, LP1, LP2 and LP3. LP1 includes six (6) lesson elements, A through F. LP2 includes eight (8) lesson elements A through H, and LP3 includes two (2) lesson elements A and B. Similarly, there are two levels of grammar lessons, spelling lessons, vocabulary lessons and comprehension lessons, each level containing a set number of lesson elements.

The tutorial system and adaptive method 10 of the present invention is particularly used in the teaching of linguistics and other subjects which can be taught in discrete lessons or lesson elements, and which are inherently organized or categorized into different components each containing several lesson components. For example, algebra may be broken down into (1) solving linear equations, (2) graphing linear equations, (3) solving word problems using linear equations, (4) solving non-linear equations, (5) graphing non-linear equations, (6) solving word problems using non-linear equations, (7) matrices. Similar to the linguistics example, within each of the seven (7) dimensions of the algebra example, several levels can be created, each containing several lesson elements. These are merely examples and are not necessarily the most effective manner of dividing the subject matter, and may not necessarily be inclusive of the entire subject matter. For example, some language courses teach literature together with the traditional aforementioned categories. Some subject matters may be difficult to divide into discrete lesson levels, each containing one or more discrete lesson elements, in order to achieve an effective tutorial system. However, the present invention is particularly well suited for subjects involving linguistics, such as learning a new language or overcoming a speech impediment.

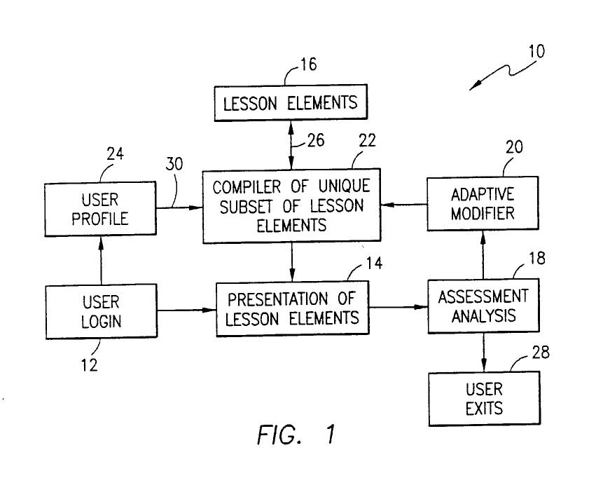

With reference now to the drawings, the tutorial system and adaptive method 10 of this invention is depicted in a series of block diagrams or flow charts for ease of illustration. Each “block” is representative of a method step according to this invention which is implemented by hardware and/or software, as described below. The method 10 herein is broadly described with reference to FIG. 1, which depicts more general or abstract aspects of the subject invention, followed by a discussion of more specific embodiments and applications of the inventive steps herein. Unless otherwise stated, it is assumed for purposes of discussion that a single individual is identified by the term “user.” Nevertheless, as described below, the method 10 and system of this invention can be utilized by a group of users or cohort, as desired.

Considering first FIG. 1, block 12 depicts the initial step of logging into the system, e.g., a computer terminal or workstation, dialing into a telephone-based system, or initiating a custom, stand-alone application as described below in connection with a discussion of FIG. 6. Once in the system, the user is presented with an initial lesson as represented by block 14. This lesson may be a first subset of lesson elements assembled from a universal set of lesson elements stored in database 16. The presenting step depicted by block 14 may be representative of a presentation unit or subsystem such as a computer screen, a set of speakers, a telephone receiver, a television set or any device that can be used to communicate lesson elements and the related software functional blocks such as software to drive the monitor, microphone, telephone and software to transmit, receive and decode the data and commands, such as browser software, voice storage and recognition software, etc. Block 18 is representative of an assessment function of the system implemented by software, used to test whether the user understood and learned the educational components of the lesson elements. Each lesson element contains at least an educational component, designed to teach the user and may include practice routines or instructions, and an assessment component, designed to determine whether the user understood, captured and retained the lessons taught. In the assessment analysis step of block 18, the system obtains user responses to the assessment components of the lesson elements and compares the user responses against correct, predetermined assessment responses. The assessment component is a test and the predetermined assessment responses are answers. The results of the comparison between the user responses and the predetermined assessment responses are represented by a signal used by the next step in the method 10, represented by block 20, which is characterized as a “modifying” step wherein an adaptive modification routine is performed in the software of the system to adaptively modify the next set or subset of lesson elements presented to the user. Hence, the assessment function of block 18 and modifying step of block 20 represent a negative feedback loop to determine what lesson elements the user will be presented with next.

In FIG. 1, an additional compiling step is illustrated with reference to block 22. This step is included in order to illustrate the assembling of the lesson elements based upon a feedback through the adaptive modifier 20. However, the compiling step of block 22 can be combined with the adaptive modifying step of block 20 to form one functional block in the system or process. Also included in FIG. 1 is functional block 24 illustrating that the user or cohort is represented by a user profile. This functional block 24 is included to illustrate that the user's profile is a positive feedback impacting on the determination of the lesson elements selected for the user. The user profile step depicted by block 24 may input directly into the adaptive modifying step of block 20. However for ease in explaining the system, the user profile block 24, which may be representative of the step of inputting a user or cohort profile, is illustrated as affecting the compiling step of block 22. The profile block 24 also represents forming a cohort from multiple users wherein the cohort of users has similar characteristics, e.g., age, prior educational experience, skill level etc. The system 10 includes a communication link 26 between the compiler block 22 and the database of lesson elements in block 16. Similar reference numerals represent similar components, steps or concepts throughout the drawings.

A high-level explanation of the functioning of the tutorial system follows. The user enters the system 10. Once in the tutorial system, the compiler function of block 22, with information regarding the particular user obtained from the profile, assembles a first subset of lesson elements which take into account that user's profile. The first subset of lesson elements are retrieved from the database block 16 and presented to the user at block 14. The user inputs responses to the assessment components of the lesson elements. At block 18, the system compares the user responses against predetermined assessment responses. The results of the comparison, e.g. a signal, is utilized at block 20 to create a unique second subset of lesson elements based upon the user's assessment responses. Accordingly, the second subset of lesson elements are adaptively created to take into account the user's performance on the first subset of lesson elements. The second subset of lesson elements can be taken from the first subset of lesson elements or from the database block 16 of the universal set of lesson elements or a combination thereof. The second subject of lesson elements is transmitted as a signal to block 14 where they are presented to the user for further study, which may be remedial or cover new subject matter, depending upon the user's progress. The process is repeated until the lesson is complete or the user exits the tutorial system 10, as at block 28.

FIG. 1 illustrates the concept of using positive feedback and negative feedback to adaptively modify the lesson plan for a user. The user information or profile represented by function block 24 provides a positive feedback depicted by line 30 connected to the compiler block 22. This information provides a forward looking basis for determining the first subset of lesson elements to be presented to the user. In a linguistics tutorial, for example, the information contained within the profile may include information about the user's native language, the language spoken in the user's home, the language spoken in the user's work place, the educational level achieved by the user, the user's academic background, the user's linguistics goal, i.e., does the user only want a working knowledge of the language or is the user learning the language for a vacation to a foreign country, the time within which the user desires to complete his or her linguistics goal, the user's anticipated study frequency, results from language proficiency tests and/or, any language disability or speech impediments the user may have. The following is an exemplary profile for a user desiring to use a linguistics tutorial:

### Student/User Profile Table

User Background Information:

Name

Address

User Identification

Password

Native Language

Secondary Language

Other Language

Proficiency Rating (Grading)

Educational Profile:

Lesson Date Complete/In Progress Level Grade

The user background information is particularly useful in determining the initial set of lessons to provide the user. Using the linguistics tutorial example, if the user speaks the language that the user is learning at his or her workplace, then the initial subset of linguistic lesson elements presented to that user will be slightly more difficult than the lesson elements initially presented to a user studying the same language who does not speak the language at the workplace (given that all other relevant factors are relatively similar). If the user has used the system before, the profile may include an educational component with information regarding lessons completed, the date completed, lessons in progress and assessment information or grades received. The user profile data, including the educational component, may also be useful in determining the initial set of lesson elements presented to the user the next time the user accesses the tutorial system. Hence, the user profile provides a positive feedback or forward looking criteria for determining the lesson elements presented to the user.

The feedback loop, represented by the assessment block 18, the adaptive modifier block 20 and compilation block 22 represents a negative feedback or rearward looking criteria to adaptively modify the user's lesson plan based upon past performance. The results of the user responses to the assessment components of the lesson elements are used to determine a unique second subset of lesson elements customized to meet the needs of that user. Utilizing the linguistics example, if a student scores perfectly on all the assessment components of the lesson elements presented, then the student is probably ready to move on to the next level within the linguistics tutorial. The perfect scores represent a negative feedback because the output or result of the user's assessment responses is being utilized to determine the next set of lessons. Accordingly, the tutorial method 10 of this invention encompasses positive feedback and negative feedback to alter or modify the lesson plan for a particular user. The same model applies to a group or cohort. Scores may be perfect, pass-fail or graduated (A, B, C, etc.).

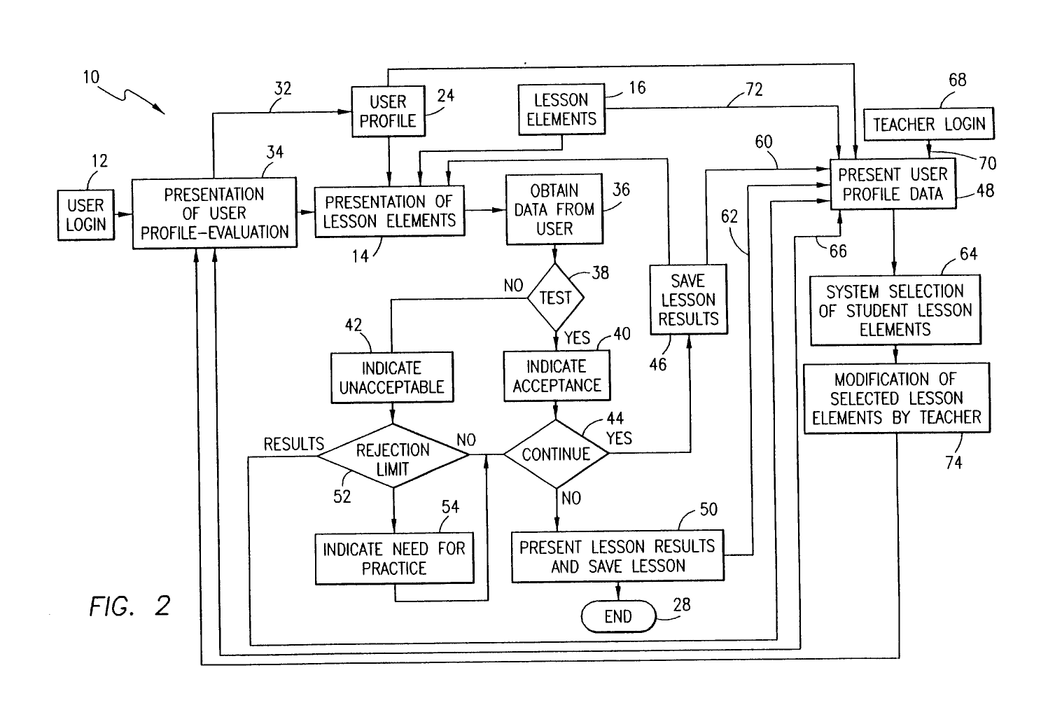

FIG. 2 diagrammatically illustrates the major components or functional blocks of a flow chart describing in greater detail the tutorial system and method 10 of the present invention. The user logs into the system 10 at block 12. Block 12 may include prompting the user for a user identification and password to verify that the proper party is accessing the system. The identification and password may be used to retrieve the user's profile from the user profile database at block 24 via communication channel 32. Although depicted as a separate database, the user profile database of block 24 may be incorporated into the lessons database or lesson elements of block 16.

The next step is presenting the user with his or her user profile. Block 34 is representative of displaying not only background information about the user, but also results from prior tests or assessments, reminders, updates about the system and other learning experiences and services available. The particular location of the user on a learning curve (a graphic proficiency indicator) may be helpful to the user as an inspiration to go forward. The user presenting block 34 can be accomplished via a variety of devices, including a telephone, facsimile, Internet, mobile telephone, computer monitor, or other devices capable of communicating such information to the user or student. Thus, the step of block 34 allows the user to access detailed information about his or her progress in learning the particular subject and the availability of other lessons. The profile information or user data will be used in connection with the tutorial system's selection of the first subset of lesson elements to be presented to the user. Block 34 is also representative of functionality to obtain user information or user data when none exists or new data is required, and may also include making an initial evaluation (an assessment) of the user's proficiency in the particular subject matter being taught. If the user has never logged into the tutorial system 10 before, or if the user has not accessed the system in a predetermined period of time, the system will prompt the user to input the appropriate information and will conduct an initial evaluation. This initial evaluation may be a simple questionnaire requesting that the user input biographical data and other data similar to the fields identified in connection with the linguistics tutorial example. Other fields may also be appropriate depending upon the subject matter. The initial evaluation may also include a basic skills assessment to determine the user's proficiency in the particular subject matter. If the user has utilized the tutorial system in the past, but a predetermined period of time has elapsed since the last use, the system may present the user with an evaluation to test whether the user retained the proficiency level of the last lessons successfully completed. The predetermined period of time will vary, depending upon many factors such as the subject matter involved, the particular goals of the user, and the study time allotted by the user. Upon completion of the evaluation, if an evaluation was required, and being presented with the user profile, the tutorial system advances the user to the next step.

The tutorial system and method 10 prompts the user regarding an initial set of lesson elements at block 14. The initial set of lessons may be presented via a wide array of devices similar to those described in connection with the presentation of the user profile. The initial set of lesson elements, as previously discussed in connection with FIG. 1, are a subset of a plurality of lesson elements or a subset of the universe of lesson elements available in the lessons database at block 16. In one embodiment, the functionality represented by block 14 includes allowing the user to choose from a group of lesson elements, e.g. giving the user the option to select what particular lesson element the user desires to complete first, or giving the user a group of lesson elements from which the user must complete a percentage to move on to the next level. For example, in a linguistics tutorial system, if the lesson elements involved learning the word “bat”, the user may be given the choice to complete the pronunciation or phonics lesson element first and then complete the spelling element later and other elements subsequently.

The lesson presentation step of block 14 encompasses not only the presentation of the lesson elements, but also the presentation of the lessons' component parts. Accordingly, a lesson element will usually commence with an educational component which can include several exercises and examples. Utilizing the linguistics example, an educational component may include practicing the pronunciation of the sounds necessary to complete the pronunciation of the entire word. The educational component may include displaying a graphic representation of the word if the system includes a monitor, or audibly broadcasting the pronunciation of the word via a speaker if the system is a telephonic device or includes speakers. For example, if the system is operating on a user computer or workstation, a wave file could be included in the educational component which the client computer will play through its audio components.

The educational components may also utilize practice rounds. The tutorial system may prompt the user to practice a particular word or sound. In an embodiment utilizing a microphone, the user can record a practice response which can be played back. Through this feature, the user can listen to the difference between the correct sound or pronunciation and his or her own pronunciation. Other educational components can be incorporated including interaction with other users completing the same lesson element or studying the same subject matter.

As previously described in connection with FIG. 1, the lesson elements also include an assessment or examination component. The purpose of the assessment component is to measure the user's mastery of the lesson elements. The assessment components can vary widely depending upon the subject matter and the educational goal of the user. For example, a user utilizing a linguistics tutorial to learn a language because he or she is visiting a country on vacation will not need to master the pronunciation of the words as well as a business professional learning the language in order to effectively communicate with foreign business prospects or associates.

After presenting the lesson elements at block 14, (electronically from a web server via a browser, or via a server on a LAN or WAN, or via a computer with digital representations of audible data), the system prompts a user for responses to the assessment components of the lesson elements at block 36. The user responses may be audible, textual, tone generated (DTMF) or a combination. If the tutorial system encompasses a telephone system, the user may indicate his or her responses by pressing the appropriate keypad numbers or symbols, by audible response (e.g. voice) or a combination through the use of the user's telephone. The tutorial system 10 can accept dual tone modulation frequency (DTMF) data or include hardware to convert the sampled analog voice to digital data. If the adaptive teaching method is implemented utilizing a global telecommunications network, such as the Internet, then each client computer may be equipped with an Internet browser or any other HTML-based system for browsing Internet sites. The tutorial system may incorporate the use of VoiceXML, an emerging standard in markup languages for creating voice applications. Likewise, the tutorial system may also incorporate voice recognition technology to compare and assess user audible responses to predetermined audible responses. Such technology may require a training step (for the computer systems) in which the user submits a battery of predetermined audible samples to “train” the system to recognize or decode the particular user's speech patterns. The tutorial system may also utilize text-to-speech (TTS) technology that converts machine readable text into audible synthesized speech. TTS is especially useful for large directories and databases, for frequently changing information, and for circumstances where recording audio responses is deemed to be cost-prohibitive.

The user responses are then analyzed at block 38. Block 38 is representative of the assessment step depicted by block 18 in FIG. 1. Each lesson element includes predetermined assessment responses to the assessment components. The predetermined assessment responses are the “correct answers” or represent an acceptable range for user responses. The user responses are compared to the predetermined assessment responses. If the user responses are acceptable, then the user is prompted through an acceptable indicator at block 40 that his or her responses were satisfactory. If the user responses were not acceptable, the user is prompted through an unacceptable indicator at block 42. Depending upon the subject matter and other criteria such as user goals, the threshold of acceptable responses may change. Again, using the linguistics tutorial, the system may find a response from a person learning a language for a vacation acceptable, but find a similar response unacceptable from a person attempting to learn the language for business reasons.

If the user's responses were acceptable, then the user is prompted as to whether he or she wishes to continue with the lesson plan at decision block 44. If the user responds “yes” or affirmatively, the results of the user's examination or assessment are saved at block 46 and utilized by the tutorial system at block 48, described below in connection with a discussion of teacher interaction. This step may be omitted or converted into a step which permits the user to exit the program. The system then repeats step at block 14, presenting the user with the next lesson element or group of lesson elements, and the process is repeated. If the user responds “no” at decision block 44, the results of the user's assessment are presented to the user as represented at block 50, and also saved and utilized by the system at block 48. The tutorial system then logs the user out of the system as at block 28.

If the user's assessment responses were not acceptable, the system prompts the user via an unacceptable indicator at block 42 (visual, audio or otherwise) of the user's failure, and the tutorial system tests whether the unacceptable user responses have surpassed a predetermined rejection limit at decision block 52. For example, if the user has attempted the same lesson element five (5) times within a one-week period and has failed all five times, the rejection limit may be surpassed. If the user assessment responses have not surpassed the rejection limit, then the tutorial system prompts the user as to whether he or she wishes to continue at decision block 44. The subsequent steps are the same as if the user had successfully responded to the assessment components of the lesson elements, except that the system may be designed to repeat the same “failed” lesson element if the user's prior assessment responses were not acceptable.

If the user's unacceptable assessment responses have surpassed the predetermined unacceptable rejection limit, then the user is prompted or presented with information regarding the user's deficiency and the user's need to practice or take further remedial lessons at block 54. The system then prompts the user regarding continuing the lesson at block 44 and the adaptive methodology proceeds as if the rejection limit had not been reached, except that the system may present additional lesson elements from the same level or other levels as that of the lesson element which the user failed to give acceptable user assessment responses. Alternatively or additionally, the rejection limit data can be used to modify the educational component of the user profile such that the next subset of lesson elements assembled or selected for the user accounts for the user's deficiency.

One of the objectives of the present invention is to reduce the extensive resources required for individualized teacher/student interaction. Accordingly, the teacher interactive facility shown in conjunction with tutorial system on the right hand portion of FIG. 2, described below, is optional. In the embodiment without teacher interaction, the method of this invention compiles a first subset of linguistic lesson elements based upon the user's profile without teacher interaction. Hence, the system utilizes the user profile data at block 24 to selected and assemble the initial subset of lesson elements. The first subset of lesson elements are then presented to the user at block 14, as previously described, and the system progresses through the functional steps previously identified and described. Upon the user completing the lesson elements, i.e. performing the assessment components of the first subset of lesson elements (at block 36), and the system comparing the user responses against predetermined assessment responses (at block 38), the results as depicted by lines 60 from block 46 and line 62 from block 50 are transmitted to the block 48 where such user profile data is presented. As represented by block 64 connected to block 48, the assessment components of the completed lesson elements are used by the system to adaptively modify the compiling of the next set of lesson elements to assemble a unique second subset of lesson elements based upon the user's results. Similarly, the system incorporates user deficiency information viz-a-viz feedback from block 52, represented by line 66 connected to block 48, to determine the unique second or subsequent subset of lesson elements.

Another embodiment of the tutorial method 10 incorporates a teacher interactive facility. The teacher may actually be an administrator or a fellow student who has mastered the particular subject matter. The teacher may log into the tutorial system at any time, even before the user has accessed the system, in order participate in crafting the lesson plan for a user or cohort of users. As previously described, the tutorial system is designed to be automated such that little or no teacher interaction is required. In FIG. 2, the teacher logs in at block 68. This step may also include presenting a user identification and password. A profile for that teacher may be stored which would allow the teacher to access only specific information about his or her students. Security protocols may be incorporated into both the user and teacher access steps or routines to preserve the integrity of the system and to protect the privacy of those utilizing the system. Block 68 may incorporate presenting the teacher choices or menus that would allow the teacher to access information regarding a particular user or cohort.

The tutorial method 10 then presents the teacher with a particular user or student profile (or a profile for a cohort) at block 48. The user or cohort data may be accessed via communications channel or link 70. The system may also present the teacher with available lessons or lesson plans via link 72 connected to the lesson elements database at block 16. The tutorial method 10 then compiles a first subset of lesson elements based upon the user or cohort profile data, which may include both background information and educational information, at block 64. For example, if the user or cohort has previously utilized the tutorial system, then the compiling step takes into account results of assessment components of previously executed lesson elements.

The assembled lesson elements are then presented to the teacher at block 74. The teacher is given an opportunity to review the unique subset of lesson elements assembled for a particular user or student, or cohort. The teacher may then modify the lesson plan for the user by selecting lesson elements from those assembled by the tutorial system, by arranging the order in which the user or users is to perform the lesson elements, or by requesting that the tutorial system assemble further lesson elements in a particular area which the teacher feels requires further study. After the teacher has accomplished this task, the lesson elements are presented to the user at block 14 through its connection to block 34. The tutorial method 10 then operates as previously described in connection with the user's interaction with the system. It should be understood that the functions represented by blocks 48, 64 and 74 may be considered as a single functional step 64, or as comprising the adaptive function of the system identified by block 20 in FIG. 1.

The adaptive modification of the compiling of the subsequent subset of lesson elements of step 64 in FIG. 2, as represented by the function block identified as adaptive modifier 20 in FIG. 1, may be accomplished in numerous ways. For example, if a user's responses to previously completed assessment components of lesson elements indicate a weakness or deficiency in one particular area, such as spelling in the linguistics tutorial, the compilation of the subsequent subset of linguistic lesson elements may include aggregating additional lesson elements from the group of lesson elements at the same level from which the weakness or deficiency was detected. Alternatively, or in combination with additional lesson elements from the same level, additional lesson elements from different levels of the same linguistic lesson may be assembled to form the subsequent, unique subset of lesson elements. For example, the user may have good comprehension but poor spelling. He or she would be given spelling lesson elements at a lower level and comprehension lesson elements at a higher level. Hence, the system adapts to the specific student's needs and strengths.

The steps described in connection with the functioning of the tutorial method 10 are repeated to complete a series of lesson elements in order complete an entire lesson plan, i.e., to complete the learning of a particular subject matter.

The tutorial system and method 10 may include other pedagogical models. The tutorial system may be utilized by two or more users to learn a particular subject matter through joint interaction and participation in the lesson elements. The participation of multiple users or a cohort in completing lesson plans may be an added feature to an otherwise individual or single user learning model or may be a learning model on its own. In the model encompassing the multiple users or group learning model as an added benefit to the individual user learning model, the tutorial system may be designed to allocate participation credit such that a user's educational profile is enhanced upon the completion of study sessions completed through interaction between two or more users. Teacher participation credits, group study credits, one-on-one credits and independent study credits are accounted for by the system.

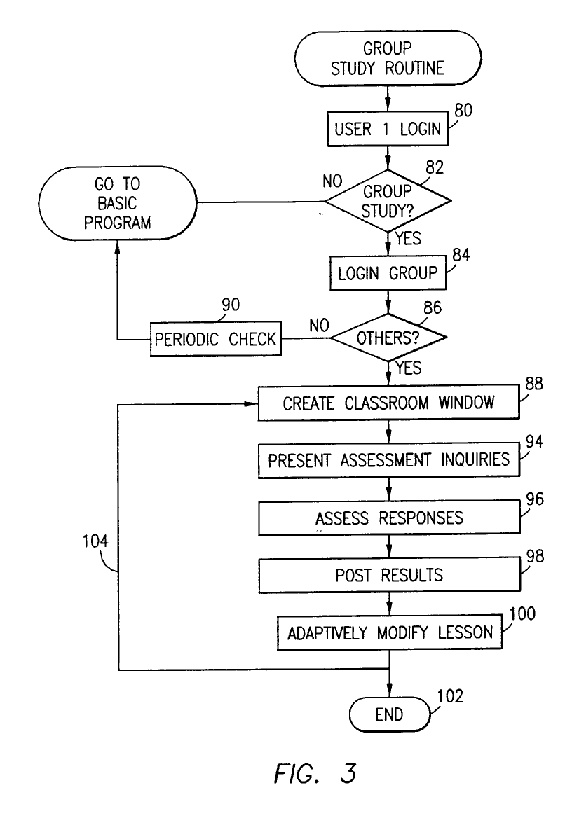

FIG. 3 diagrammatically illustrates a flow chart of a group study routine for the tutorial system and method 10 in which more than one user participates in joint study sessions. User 1 logs into the system at block 80. The login sequence and additional functions of the login are similar to the user login described above in connection with a discussion of FIG. 2. The system prompts user 1 regarding his or her interest in participating in a group study session at decisional block 82. If user 1 does not wish to participate in group study, the tutorial system functions as the “basic program,” i.e., the functions the previously described in connection with FIG. 2. If user 1 responds that he or she does want to participate in group study, then the tutorial system proceeds to the user a group login at block 84.

At the group login block 84, the tutorial system presents user 1 with possible group study lessons available to that user 1. The group study sessions available will depend upon the user's profile, i.e. what subject matter user 1 is studying, what lessons or lesson elements have been completed, biographical background, etc. The system will present group lessons which are compatible with user l's profile. The system will also test for the presence of other users logged into the system who have similar profiles (as cohort) and who are also interested in participating in group study at block 86. If other users are present, the system communicatively links user 1 to the other participating users (even if there is only one other user) at block 88. If no other users are available for group study, the system directs user 1 to individual study, using the basic program previously described in connection with FIG. 2, via a functional block 90 identified as a periodic check in FIG. 3. The tutorial system continues to poll the system at predetermined intervals of time at block 90 to determine whether other users have subsequently logged into the system interested in group study. If another interested user does log into the system for group study, the tutorial interrupts user 1 to notify user 1 of the new opportunity. The user may then either elect to continue with individual study or commence a group study session.

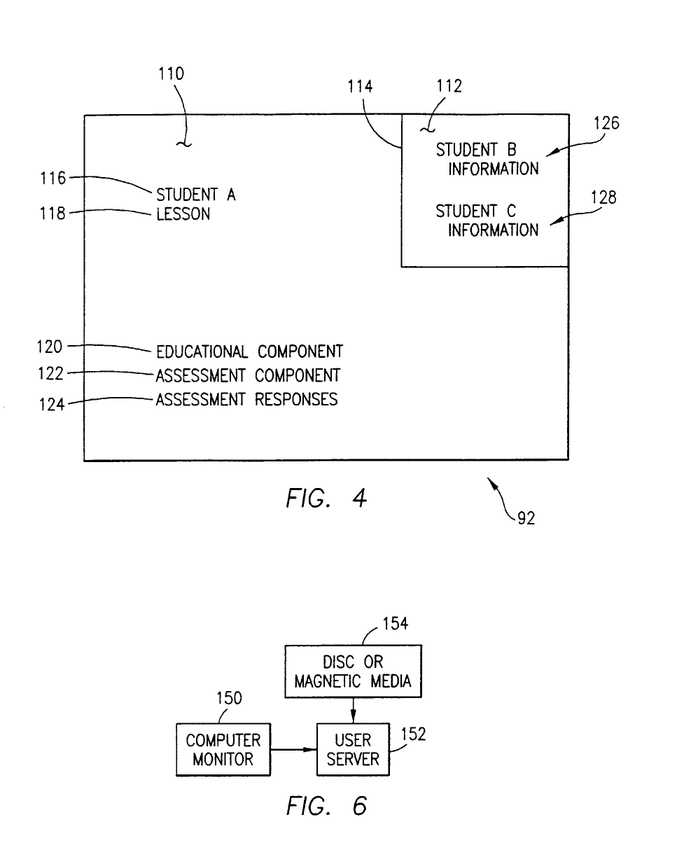

The tutorial system and method 10 as applied to two or more users functions similarly to the tutorial system described above in connection with FIGS. 1 and 2. Once there are at least two users available for group study logged into the system, i.e: a cohort, the tutorial system proceeds to link the cohort together at block 88. If the adaptive teaching method 10 is embodied in a networked system such as a LAN, a WAN, or the Internet, the system server computer presents each client computer a classroom window identified with the reference number 92 in FIG. 4. The tutorial system and method 10 presents the cohort, including user 1 and the other users, with a predetermined subset of lesson elements based on the cohort's profile at block 88. In a networked computer system, the tutorial system server presents the predetermined lesson via the individual users' client computers. The cohort may meet, via computer, at a predetermined day and time. The lessons may include educational components designed for group dynamics including practice rounds or practice problem solving in which the cohort may participate together in real time.

The cohort (multiple users) is then presented with assessment inquiries or components at block 94. The tutorial system then obtains, from at least one of the users, respective user responses to assessment components in the presented first subset of lesson elements at block 94. The system then presents the respective user responses to all in the cohort at block 94. Each member of the cohort assesses the other user responses from the cohort at block 96 and gives his or her own response, i.e. users can make individual determinations whether the presented user responses are correct. Accordingly, each user in the cohort responds by confirming the user responses, by rejecting the user responses without further response, or by rejecting the user responses and including his or her own response. As such the system obtains from one or more users of the cohort either a confirmation, a rejection without further user responses, or a rejection with further user responses. The tutorial system then compares the multitude of user responses to predetermined assessment responses at block 96. The results of the comparison are posted or presented to each member of the group at block 98. The system is effective to adaptively modify the first subset of lesson elements from block 98 to obtain a unique second subset of lesson elements customized for the group of users represented by block 100. The system may customize the individual responder without altering other profiles in the cohort. The system server will also make changes to the profiles of the two or more users participating in the group learning lesson at block 100. Each member of the group may either log out of the system, as a block 102, or continue with the next group lesson represented by line 104 leading back to block 88.

In the preferred embodiment, the universal set of lesson elements will also include lesson elements particularly useful in group dynamics. Such lesson elements can be designed to vary along a continuum from competitive to cooperative to collaborative. Competitive lesson elements or tasks may involve incorporating a winning or losing dimension. Cooperative tasks involve finding a solution to a posed problem for which there is a known answer. Collaborative tasks involve finding possible solutions to a posed problem for which there is not a definitive answer.

Lesson elements or tasks may embody a multitude of forms as determined by the nature of the course or subject matter, and/or the specifications of the teacher. For example, the lesson elements may include tandem tasks, tag-team tasks or tasks which are performed sequentially by two or more users, or tasks in which each user performs a predetermined task in order to accomplish a larger goal.

FIG. 4 diagrammatically illustrates an exemplary display for a multi-user embodiment of the tutorial system in which the system is embodied in a networked computer system. As previously described, at block 88 in the group study routine illustrated in FIG. 3, the cohort is presented with the lesson elements. FIG. 4 illustrates the use of a split screen to provide a user workspace 110 and a user communication space 112 separated by border 114. The user workspace 110 provides a medium to present user profile data 116, lesson information 118, lesson educational component information 120, lesson assessment component information 122, and assessment responses 124. The user communication space 112 provides a medium to present the user with a communication link with other users of the cohort. In FIG. 4, information regarding student B at 126 and student C at 128, and their responses to the lesson, are presented. Workspace 110 maybe one open window browser and workspace 112 may be a second open window browser. Alternatively, instant messaging or chat room software may be utilized for workspace 112.

The communications among the cohort can be accomplished through a live chat room or email service that enables each user to communicate with other member of a group, sometimes accomplished via instant messaging (IM). In one embodiment, each user of the cohort has a private list of instant messaging addresses for the other members of the cohort imported into the client computer instant messaging system. This method can also be utilized to notify the user when other members of the cohort are available for group study. The chat room is a real time electronic forum in which the users of the cohort can exchange ideas on a particular subject, participate in group problem solving and ultimately group assessment.

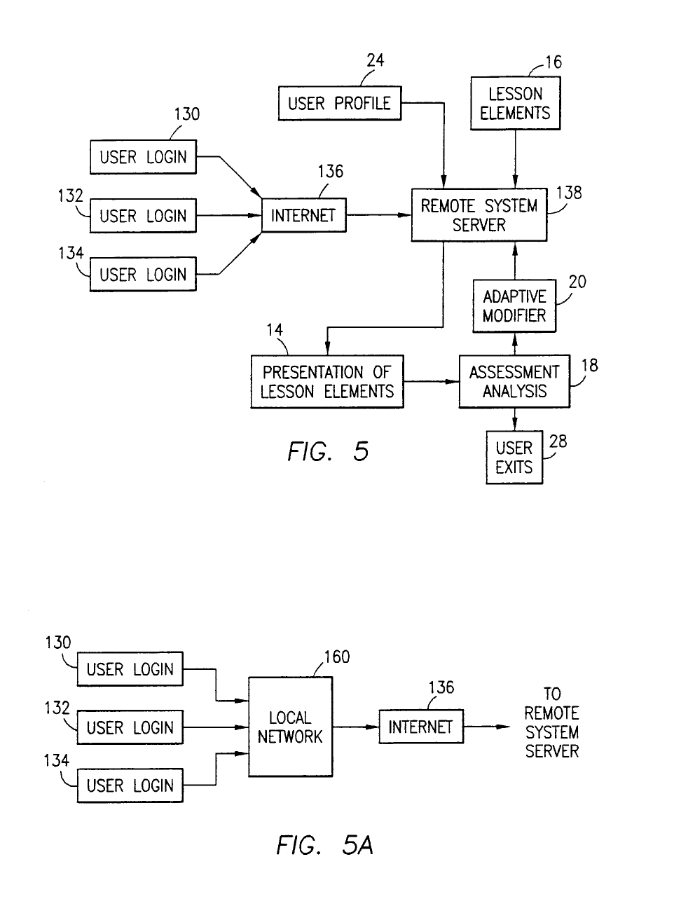

FIGS. 5 and 5A diagrammatically illustrates the use of networked technology to implement the tutorial system and method of the present invention, for use by any number of users, from one to two or more users. A number of user login blocks 130, 132 and 134, representative of a computer or other individual workstation, are linked via an Internet connection at block 136 to a remote tutorial system server 138 of a computer system. Such a connection may be individually from a computer to the Internet, or through a local area network or described in connection with a discussion of FIG. 5A below. Use of the Internet and a local network allows two or more users to communicate with each other through each user's individual workstation 130, 132 and 134 via a local network and with other users not on the local network via the Internet connection at block 136. The local network is linked to the Internet block 136, through which each user can access his or her own account via the system server 138.

In the network-based embodiment, the remote system server 138 controls the compiling and distribution of lesson elements, the gathering or obtaining of user responses to assessment components of lesson elements (responded to at the client computers user workstations 130, 132 and 134), the comparing of user responses to predetermined assessment responses, the adaptive modification of the compiling of further lesson elements to take into account the user's prior lesson results, teacher interaction, and other major functions. This functionally is diagrammatically illustrated in FIG. 5 as including blocks 14, 18 and 20, as described above in connection with FIG. 1, although it should be understood that all of these functions could be incorporated within the system server 138. The system server 138 has access to all users' profiles via block 24, and to the universal set of lesson elements at block 16, as discussed with reference to FIG. 1. User profile data and the lesson element data may be stored in a single database or multiple databases 24, 16 directly accessible by the system server 138 as illustrated in FIG. 5, or remotely stored in databases accessible by the system server 138 via a telecommunications network or through the Internet connection at block 136.

The method, system and computer program to establish and implement the tutorial system is operable on a computer system depicted in FIG. 6 or on a network as shown in FIGS. 5 and 5A. The individual system of FIG. 6 includes a display or computer monitor 150, a central processing unit or user server 152, a keyboard or other manual user input and a microphone (not shown), which may be separate or contained within the monitor unit 150. The server 152 includes various memory devices and a processor. Particularly, a reader is utilized in conjunction with a disc or magnetic media represented by block 154. The tutorial system may include an initiating computer program that is distributed through a compact disc or magnetic media 154. The disc includes executable code as well as instructions on use of the tutorial system. The initiating computer program could also be distributed via the Internet through a web site or bulletin board.

In the embodiment of FIG. 5A, the system and methodology is deployed over a network 160 having a plurality of computers 130, 132 and 134 (typically, user or client computers) which may be connected together over local network for example, in a classroom or library environment. The local network 160 is connected via a telecommunication or communications link and input/output device to the Internet as at block 136. In turn, the remote system server 138 and the remainder of the computer system depicted in FIG. 5 is connected to the user via the Internet at block 136. The server 138 has access to the plurality of lesson elements or the universal set of lesson elements 16. As an example of implementation of the tutorial system over the Internet, the user inputs significant amount of information into the system via keyboards, a microphone, or other peripheral devices attached to the client computer. The browser on users' computers 130, 132 and 136 calls a routine on server 138 such that server 138 provides data input screens enabling the user at one of the computers, for example, computer 132, to input information such as user profile data or user responses to assessment components of lesson elements. Tutorial system hardware, software and communications components provide the means to obtain such data.

Upon obtaining the user responses, the computer program on server 138 utilizes the information to complete the previously described steps, such as comparing the user responses to predetermined assessment responses and adaptively modifying user lesson plans. The steps described earlier in connection with FIGS. 1, 2 and 3 are completed automatically. Some operator, teacher or administrator input may be necessary, but not necessarily essential. The subsequent, unique subset of lesson elements developed at server 138 is downloaded and displayed to the user computer 132.

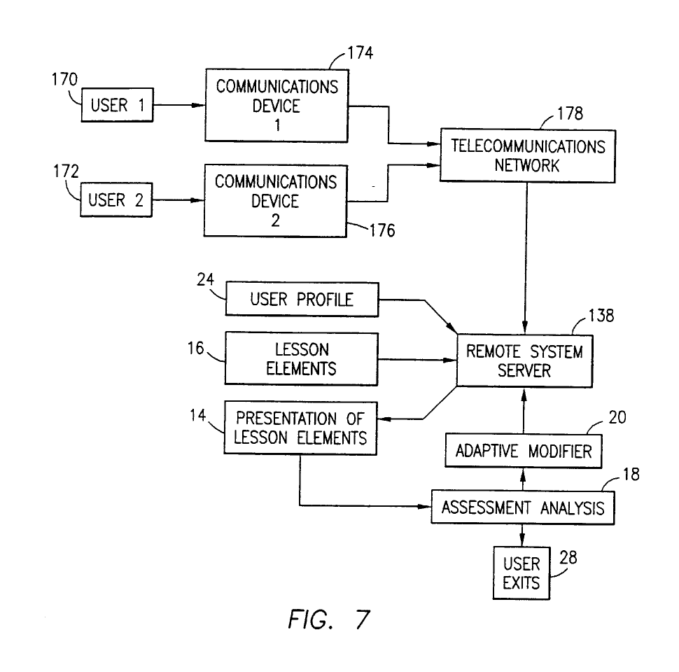

In another embodiment of the present invention, the tutorial system and method 10 are presented to the user via a user's communications device over a telecommunications network. With reference to FIG. 7, the tutorial system is embodied in a telecommunications system linking respective users 170 and 172 via corresponding communications devices 174 and 176 to a system server 138 via the telecommunications network 178. The communications device depicted by block 174 is a telephone connected to a land line, whereas block 176 is representative of a mobile or wireless telephone. The telecommunications network 178 is connected to a remote server 138 which operates in the same manner, and using the same functional elements, as shown and discussed in connection with FIGS. 1 and 2.

The tutorial system and method utilizing telecommunications network 178 to present lesson elements via a user's communications device works substantially similar to the systems described earlier in connection with the computer based systems. The interaction of the users 170 and 172 are limited to a combination of audible responses and manually input signals through use of keypads on the telephonic devices 174 and 176. As described earlier in connection with FIG. 1, the tutorial system can accept dual tone modulation frequency (DTMF) data or include hardware to convert the sampled analog voice to digital data. The tutorial system may also incorporate voice recognition technology to compare and assess user audible responses to predetermined audible responses. A training step in which the user submits a battery of predetermined audible samples to “train” the system to recognize or decode the particular user's speech patterns may be required. TTS technology would be especially helpful in operating the tutorial system over a telephonic telecommunications system.

In the embodiments of this invention which employ a link between the user(s) and a remote system server 138, such as an Internet connection (block 136 is FIG. 5, for example), the system and method 10 of this invention is operative to allow the user to study offline at least at times. Lesson elements can be downloaded into the memory at the workstation or computer of the user from the remote server 138, during which time the user may disconnect his or her link via the Internet to the computer system. This is especially advantageous considering continuous use of an Internet connection occupies a telephone or DSL line, and inadvertent disconnects with the Internet are quite common which could interrupt the session of a user and perhaps result in lost data. If the user proceeds with a lesson to the point of the system adaptively formulating a new or second subset of lesson elements, and all or some of the new lesson elements are not present in the memory of the user's computer, the system 10 is operative to re-establish a connection to the remote server 138 via the Internet or other telecommunications network and obtain additional content from the lesson element database.

From another perspective, the tutorial system and method 10 of this invention is a content engine. The following discussion provides a more detailed description of elements of the system and software employed in the method of this invention, the functionality of which are diagrammatically illustrated in FIGS. 1-7. The intelligent content engine generator system ICEGS is a method for automating the configuration of content for the learning software and a system called E-CALMS (Examinee-Configured Adaptive Learning Management System). The system breaks down content into a curricular taxonomy of up to eight course levels. ICEGS also configures standard “participation” units that can be used with a subsystem called I-PALMS (Intelligent Participation Adaptive Learning Management System) so as to provide automated, robust interactivity in the online learning environment.

ICEGS is a method for producing structured content for teaching and/or learning language and other disciplines over the Internet using twinned content expert-configured software. The “twinned” concept is the dynamic updating of the user's profile during the tutorial such that a teacher, whenever the teacher logs onto the system, can determine the student's progress and provide online, real-time assistance.

The adaptive method disclosed herein overcomes the problem encountered in prior art systems which just “dump” text and other course material into a software environment for distribution to learners. In the present system, content is adapted to the student dynamically with an expert engine which is intimately involved in the flow of the content generation process on a page-by-page or frame-by-frame basis. Its ICEGS component generates shareable courseware objects (lesson elements) that are interoperable, durable, computer-based course or course components and which are packaged with sufficient information to be reusable and accessible. Such courseware objects correspond to industry standard reference models that define the interrelationship of course components, data models, and protocols.

The present system, using ICEGS, produces tags that can identify successful methodologies of teaching components for a particular cohort or group of learners in assembling the course components In a similar manner, failed methodologies are identified and points of potential correction for the system operator. ICEGS is programmed to vary the depth at which it constructs the curricular hierarchy. For example, “The Marine” pedagogy model (a military educational program) calls for eight course levels, the Army and Airforce five, and the Canadian level four.

ICEGS generates small, reusable, and interoperable pieces of learning content or assignable units, i.e., educational components and assessment components, grouped into larger lesson elements, which, in turn, are grouped into a lesson plan. These re-usable units are used with complex learning management systems such as E-CALMS (the adaptable subset of lesson elements constructed by the system for a tutorial to a particular student or user) so as to assemble, redefine, and re-order learning content to adapt to the needs of the online student.

Information technology applications increase both the effectiveness and efficiency of training. On average, the student in the face-to-face classroom is asked about 0.1 questions per hour. On the other hand, tutored students can be asked up to 120 questions per hour. The performance of tutored students can exceed un-tutored students by as much as two standard deviations. Raising achievement by two standard deviations is equivalent to raising the performance of 50^{th} percentile students to that of 98^{th} percentile students.

In the time-bound, place-bound face-to-face classroom it has been found that students receive only about 10 seconds of individual attention for every hour of class. Sadly, this equates to only one full week of individual instruction for the previous 13 years of pre-college school attendance. By extension, this ten-second-criteria would translate to 450 seconds or about eight minutes of individual treatment for a college level course. The unforgiving time constraints of the synchronous classroom preclude lengthy teacher-student interactions. Touting the promise of computers, Bill Gates observed in 1995, “Technology can humanize the education environment”, as a means to defeat the classroom calculus of time and place

While the effectiveness and efficiency of applications of information technology has been demonstrated, there had been no systematic way to develop and convert training materials for technology-based presentations. ICEGS systematically defines, designs, develops, and delivers content in standardized content shells, for use with E-CALMS and I-PALMS, i.e., participation units for single study, one-on-one study, group study and study as a teacher with another online student, and the consequential award of “participation units” for these activities.

One implementation of E-CALMS, the Examinee Configured Adaptive Learning Management System, provides a user interface that offers multiple screens to a user that delivers course content in learnable increments. The learning method, system, management system and apparatus of the preferred embodiments of the present invention provide an integrated system which (1) enables examinees to be evaluated online, (2) receive personalized, twinned lesson plans, that is, student and teacher-configured educational software (which may be remedial in nature) which are linked by subject and level, (3) provides customized course instruction, (4) provides matching of a student into a level-appropriate online classroom for the subject area, (5) enables the student to obtain access to a life-time personal learning profile for the subject area (the data stored in the user profile), and (6) enables the student to enter the learning management systems via a learning-curve button (a lesson selector system enabling the user to select the lesson subset to his or her liking) with nomadic access via a computer.

The Intelligent Participation Adaptive Learning Management System I-PALMS is an interactivity platform, system, and method for online peer learning and interaction using student “participation units” as learning currency. It provides for a robust distributed cooperative learning and teaching interactive learning environment.

More particularly, the Intelligent Content Engine Generator System ICEGS employed in the system and method 10 herein is a software package and method for automating the configuration of content. It dissembles or breaks down lesson plan content into a curricular taxonomy of up to eight course levels.

### Exemplary Course Level Table

| | | | |
|---|---|---|---|
| 1. | Course | e.g. | English for Speakers of other |
| | | | Languages (ESL) |
| 2. | Phase | e.g. | Pronunciation |
| 3. | SubCourse (Annex) | e.g. | Consonants |
| 4. | Lesson | e.g. | /P/ |
| 5. | Task | e.g. | aspiration |
| 6. | Learning Objective | e.g. | learn voiceless bilabial consonant |
| 7. | Learning Step | e.g. | differentiate “pat” versus “bat” etc. |
| 8. | Participation Units | e.g. | 1 unit for each: |
| | Individual | e.g., | Do E-CALMS tasks |
| | Buddy | e.g., | Co-practice phrases/tests “Give |
| | | | the cat a PAT/BAT/VAT” |
| | Team | e.g., | Solve: Contest: “How are P |
| | | | and B similar? |
| | Circle | e.g., | Solve: Cooperate: “What are |
| | | | the voiced sounds in English?” |
| | Community | e.g., | Solve: Collaborate: “Best |
| | | | Tricks for Overcoming an |
| | | | Accent?” |
| | Teacher | e.g. | Submit and receive feedback |
| | | | from instructor |

The Twinned Software subsystem of ICEGS generates twinned versions of the content (lesson subset) that a student will eventually interact with. Both the adaptive modifier software subsystem and the Teacher are allowed to add, subtract, or change the initial model generated by the ICEGS system. The adaptive modifier (the Content Expert) and Teacher processes are conflated at the end of the curriculum generation process so as to generate Twinning Software as part of the E-CALMS system.

A method for training, teaching, and evaluating by use of Twinning Software is used for each subject and level area. For example, teachers might be issued the full version of Grammar Online #3T while students would be issued a more limited and adaptive version of Grammar Online #3S. Teachers master the full battery of the subject area software; students master the personalized level-appropriate subject area. The software interactively “adapts” to the student's learning curve, new skills, and experience level. Teachers access a web site via the Internet and submit responses to a test evaluation battery. Teachers are matched up into online classrooms with students. An administration system issues a report on the students' profile to an administrative server and the participating teacher. Following completion of the online class, the teacher is polled and the students' results and remarks posted in a teacher-evaluation/rating profile. Teachers are provided with examinee-configured remedial software, if necessary.

Teacher and student versions of the specific subject and level are “mirror” images. Thus, on an item-by-item level, the teacher has been trained to know where a student has erred in a particular field. In addition, the twinning software provides the teacher with appropriate materials to issue to the student for each item and a means by which to evaluate the student's response to that material or assignment. The tracking features of the software are linked to a central administration site for dual issuance of data to both the teacher and respective students With this system, it is possible for teams of online educators to teach the same students and know precisely at which point the previous teacher left off with a particular student on an item-by-item level. The student's and teacher's progress is entered each time that they connect to the web site.

ICEGS generates a tag for each reusable knowledge object (lesson element) so that the knowledge object can be identified and exported to other learning environments as necessary. The tag “approves” or validates the efficiency and effectiveness of the lesson element, which, in computer language is called “an object.” ICEGS produces tags that can identity the methodology of a particular cohort or group of learners in assembling the course components. ICEGS is programmed to vary the depth at which it constructs the curricular hierarchy. For example, The Marine pedagogy model is eight course levels, the Army and Airforce are five, and the Canadian level contains four. ICEGS generates small, reusable, and interoperable pieces of learning content or assignable units. These re-usable units can be used with a complex learning management systems such as E-CALMS so as to assemble, redefine, and re-order learning content and thus adapt to the needs of the online student.

A disambiguator is a subsystem which identifies poorly performing lesson elements or objects. An intelligent student can sometimes find ambiguity in many learning presentations. ICEGS provides for the Content Expert (adaptive modifier) and the Teacher to tag or mark the lesson element or object with a degree of “markedness” that reflects the degree of ambiguity that a particular learning step or sequence may inherently have. The “markedness” in turn can be tied to adaptive steps or a weighting system in adjusting the student's learning path. Artificial intelligence search algorithms may be used to improve the disambiguator subsystem.

The voice implemented version of the tutorial system and method 10 of this invention relates to implementing interactive, adaptive, and individualized computer-assisted instruction using telephone services by customers remotely communicating with a telephone service provider. The methods and systems can be implemented over, e.g., the Internet, an Intranet, or through a voice recognition system using the telephone or other enabled devices. In conjunction with other distribution methods, such as the Internet or Web, Voice Enabled Learning delivery results to the locations. Alternatively, in a blended learning situation, students beginning a lesson on the Web or Internet can “pick up” a lesson on a phone or phone-like device. A database keeps continual track of student progress and bookmarks for delivery of a variety of learning services. Voice Recognition Enabled Learning is an interactive instructional system realizing an event stream based educational methodology and enabling an interactive, individualized, and adaptive learning environment.

The voice based learning system herein uses rules to provide adaptive content that is customized for each user. To summarize, a grammar (either handcrafted or automatically acquired using machine learning algorithms) is used to parse the natural language query to obtain a set of semantic tags that represent the query. The query can be received either as speech, key pad entry, written text or can be translated from speech to text via a speech recognition system.

Voice enabled learning provides for assessment, feedback, and reinforcement of a particular learning step or learning object for virtually any subject by having the user interact over a phone or phone-enabled device with a software program that provides learning content. The program determines if a learner already knows or has mastered a particular learning step and presents un-mastered material to the student in an adaptive learning fashion. Furthermore, student results, reminders, updates, and other learning experiences and services can be sent to a variety of devices, including the telephone, fax, Internet, Web, cellular phones, or other devices.

The present system and method 10 herein, using an adaptive tutorial methodology combined with voice enabled learning, incorporates, among other technologies, VoiceXML, an emerging standard in markup languages for creating voice applications; speech recognition—a robust and scalable software server engine that understands what someone is saying and then performs some action based on that understanding; and, Text-to-Speech (ITS)—Technology that converts machine-readable text into audible synthesized speech. TTS is necessary for large directories, frequently changing information, or when recording audio playback is deemed to be cost-prohibitive. Consequently, a phone based training computer system is provided which is adapted to teach a variety of content using voice and other inputs from users over the telephone and other devices.

One goal of the voice enabled, adaptive learning system herein is to provide a means for distance learning through voice-based training course for customers without access to a computer or in conjunction with computers or other devices. The voice-based training course applications can allow participants to access and manage their voice-based training course accounts by phone or other devices. The application will also allow participants to receive timely information regarding test scores, account balances, course information, operator assistance, and other information. In addition, this application can help limit the need for training participants to interact with a live customer service representative to sign up for courses or to get information on new courses offered. The voice enabled system offers these training courses in multiple languages.

Advantages of the present invention include the ability to deliver adaptive, customized content for vocabulary, grammar, pronunciation, specialized lexicons for banking, science, industry, slang, math, science, and other information that must be rapidly assimilated or tested for.

Other advantages include the ability to integrate a variety of devices: land phone, mobile phones, PDA's (personal data devices), WAP phones, Internet, and the Web into a seamless learning environment.

Another advantage is the ability to deliver detailed tracking, accountability, and reportage of a user's progress on an item-by-item basis. The voice enabled system also delivers voice “home work” or other learning or training services to phones or other devices at random or predetermined intervals.

An additional advantage is the ability to be used in conjunction with a content engine for rapidly putting up content, putting up content in conjunction with Web or Internet-based learning or training products, and rendering content conformable to regulations regarding the disabled, handicapped, or learning impaired.

In addition, the voice enabled system's voice-based training course application include the following capabilities listed in the following table.

The speech user interface will support “directed dialog” speech recognition. Natural Language shortcuts/navigation will be available. Participants will be able to “barge-in” on most directed dialog prompts when appropriate. Hints, Synonyms, and Help prompts will be included where necessary and practical. Participants will be transferred to a live operator when there are too many failures/failed transactions or when the Participants requests to speak with a live person. Participants may also be offered to leave a message to cut down on live transfers. DTMF backup will be used where appropriate. Callers may hang up, at any time. The speech application will perform all account management clean up required to satisfy back-end consistency rules. Additional features may include the provision of: PINS, voice verification, mute capability, and feedback recordings. The system and method 10 of this invention also includes the ability to track a user's progress on a item-by-item basis, to be integrated with content engines for rapid prototyping of learning content, to dispatch reminders, updates, results, homework to a multitude of devices, to adopt to requirements regarding disability and handicapped issues and to be integrated into other learning systems.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

I claim:

1. A method of teaching, comprising:
(a) establishing a connection between the communication device of a user and a computer system which includes a database containing predetermined assessment responses and lesson elements having an educational component and an assessment component;
(b) presenting a first subset of lesson elements to the user;
(c) obtaining at least one response from the user to at least one assessment component of the lesson elements in the first subset;
(d) comparing the at least one response of step (c) with the predetermined assessment responses; and
(e) modifying the first subset of lesson elements to obtain a second subset of lesson elements based upon the comparison of step (d).

2. The method of claim 1 further including creating a profile for the user which is associated with the first subset of lesson elements.

3. The method of claim 1 in which step (a) includes establishing a connection via a worldwide computer network between the communication device of the user and the computer system.

4. The method of claim 3 in which step (a) includes maintaining said connection throughout a user lesson.

5. The method of claim 3 in which step (a) includes establishing said connection for a portion of a lesson, and then disconnecting the communication device from the computer system to allow the user to provide responses while offline from the worldwide computer network.

6. The method of claim 5 in which step (a) includes downloading data from the computer system into the communications device to permit the user to proceed with the lesson offline from the worldwide computer network.

7. The method of claim 6 in which step (a) includes re-establishing a connection between the communication device of the user and the computer system to retrieve additional data for use in modifying the first subset of lesson elements.

8. The method of claim 1 in which step (a) includes establishing a connection between a number of individual users and the computer system.

9. The method of claim 8 in which step (a) includes providing a local network for the connection of a number of users to the computer system.

10. The method of claim 1 in which step (b) includes creating an individualized profile for the user which is used to determine the first subset of lesson elements presented to the user.

11. The method of claim 1 in which step (b) includes allowing the user to select from one of a number of lesson elements, said first subset of lesson elements being chosen from said selected lesson elements.

12. The method of claim 1 in which step (a) includes providing a number of lessons for a particular subject on the database of the computer system, each of the lessons including a number of lesson levels and each lesson level consisting of a number of lesson elements.

13. The method of claim 12 in which step (e) includes modifying the first subset of lesson elements utilizing at least one lesson element from different lesson levels of the same lesson.

14. The method of claim 12 in which step (e) includes identifying a deficiency based upon the comparison step (d) and modifying the first subset of lesson elements to include additional lesson elements from the same lesson level as the identified deficiency.

15. The method of claim 1 in which step (e) includes allowing a teacher to assess the results of step (d) and participate in the modification of the first subset of lesson elements.

16. The method of teaching linguistics, comprising:
(a) establishing a connection over a telecommunications system between the communications device of a user and a computer system which includes a database containing predetermined assessment responses and lesson elements having an educational component and an assessment component;
(b) presenting a first subset of lesson elements to the user;
(c) obtaining at least one response from the user to at least one assessment component of the lesson elements in the first subset;
(d) comparing the at least one response of step (c) with the predetermined assessment responses; and
(e) modifying the first subset of lesson elements to obtain a second subset of lesson elements based upon the comparison of step (d).

17. The method of claim 1 in which step (a) further includes inputting profile data using the communications device and telecommunications system to create a profile for the user in the computer system.

18. The method of claim 17 in which step (a) includes inputting profile data selected from the group consisting of native language data, language spoken at home data, language spoken at work data, completed educational level data, academic language level data, anticipated study time data, anticipated study frequency data, linguistic goal data, non-native language comprehension data and linguistic disability data.

19. The method of claim 16 in which the assessment components of said first subset of linguistic lesson elements includes assessment components designed to assess proficiency in linguistics.

20. The method of claim 16 in which step (c) includes obtaining at least one audible response from the user to the assessment components presented in the first set of lesson elements.

21. The method of claim 20 in which step (d) includes utilizing voice recognition to compare the audible responses from the user with the predetermined assessment responses.

22. The method of claim 16 in which step (c) includes obtaining at least one manually input signal via the communications device of the user which is transmitted via the telecommunications system to the computer system.

23. The method of claim 16 further including the step of providing an acceptability indicator to the user after the performance of comparing step (d).

24. The method of claim 16 in which step (a) includes providing a number of lessons for a particular subject on the database of the computer system, each of the lessons including a number of lesson levels and each lesson level consisting of a number of lesson elements.

25. The method of claim 24 in which step (e) includes modifying the first subset of lesson elements utilizing at least one lesson element from different lesson levels of the same lesson.

26. The method of claim 24 in which step (e) includes identifying a deficiency based upon the comparison step (d) and modifying the first subset of lesson elements to include additional lesson elements from the same lesson level as the identified deficiency.

27. The method of claim 16 in which step (e) includes allowing a teacher to assess the results of step (d) and participate in the modification of the first subset of lesson elements.

28. The method of claim 16 in which step (a) includes establishing a connection via a worldwide computer network between the communication device of the user and the computer system.

29. The method of claim 28 in which step (a) includes maintaining said connection throughout a user lesson.

30. The method of claim 28 in which step (a) includes establishing said connection for a portion of a lesson, and then disconnecting the communication device from the computer system to allow the user to provide responses while offline from the worldwide computer network.

31. The method of claim 30 in which step (a) includes downloading data from the computer system into the communications device to permit the user to proceed with the lesson offline from the worldwide computer network.

32. The method of claim 31 in which step (a) includes re-establishing a connection between the communication device of the user and the computer system to retrieve additional data for use in modifying the test subset of lesson elements.

33. A system for teaching, comprising:
a user workstation including a communication device;
a data transmission system connected to said workstation;
a computer system connected through said data transmission system to said workstation, said computer system having a database containing predetermined assessment responses and lesson elements having an educational component and an assessment component, said computer system including:
(i) a presenting subsystem which creates a first subset of lesson elements, transmits them to said workstation and solicits a response;
(ii) a data receiving subsystem which receives at least one response of the user from said workstation to at least one assessment component of the lesson elements in said first subset, said data receiving subsystem producing a first signal representative of said at least one response;
(iii) a data comparing subsystem which compares said first signal with said predetermined assessment responses and produces a second signal representative of said comparison;
(iv) a modifying subsystem which modifies said first subset of lesson elements to create a second subset of lesson elements based upon said second signal.

34. The system of claim 33 in which said user workstation is a personal computer.

35. The system of claim 34 in which said communications device is a telephone.

36. The system of claim 34 in which said communications device is a keyboard of said personal computer.

37. The system of claim 34 in which said communications device is a microphone of said personal computer.

38. The system of claim 33 in which said data transmission system is a line connecting said workstation with a local system server within said computer system.

39. The system of claim 33 in which said data transmission system is a worldwide network of computers connecting said workstation with a remote system server within said computer system.

40. The system of claim 33 in which said workstation is a number of individual workstations, said data transmission system including a network connected to said individual workstation and via a worldwide web of computers to a remote system server within said computer network.

41. The system of claim 33 further including a user profile subsystem connected to said presenting subsystem and to said data transmission system, said user profile subsystem receiving data from the user to create a unique profile for said user.

42. The system of claim 33 in which said database of said computer system includes a number of lessons for particular subjects, each of said lessons including a number of lesson levels and each lesson level consisting of a number of lesson elements.

43. The system of claim 42 in which said data modifying subsystem is effective to create said second subset of lesson elements utilizing at least one lesson element from different lesson levels of the same lesson.

44. The system of claim 42 in which said data modifying subsystem is effective to identify a deficiency upon assessment of said second signal and to create said second set of lesson elements which include additional lesson elements from the same lesson level as the identified deficiency.

45. The system of claim 33 in which said modifying subsystem includes a teacher modification component which allows a teacher to provide input to the content of said second subset of lesson elements.

46. The system of claim 33 in which said communications device is capable of receiving an audible input from said user, and said transmission system transmits said audible input to said computer system.

47. The system of claim 46 in which said data receiving subsystem and said data comparing subsystem include voice recognition which is effective to interpret said audible input from said user and compare said audible input to said predetermined assessment responses.
